(19) United States
(12) Patent Application Publication
(10) Pub. No.: US 2011/0180595 A1
(43) Pub. Date: Jul. 28, 2011

(54) MULTIMEDIA SYSTEM

(76) Inventors: Arved Hübler, Chemnitz (DE); Michael Otto, Chemnitz (DE); Thoralt Franz, Zwonitz (DE); Sten Meinhold, Neukirchen (DE)

(21) Appl. No.: 12/675,564

(22) PCT Filed: Jun. 16, 2008
(86) PCT No.: PCT/EP2008/057567

§ 371 Date: Jan. 11, 2011

(30) Foreign Application Priority Data
Aug. 31, 2007 (DE) 10 2007 041270. 5

(51) Int. Cl. G06F 17/00

(52) U.S. Cl. 235/375

(57) ABSTRACT

The invention relates to a multimedia system having a computer, which has a browser for accessing an address, in particular an IP address, a card reader connected to the computer and at least one data card having a card code and insertable in and readable by the card reader, the card reader producing a data signal dependent on the card code for the computer. The data signal of the card reader is designed so that it corresponds to keyboard signals for the direct control of the browser using a certain address.

The invention relates to a multimedia system having a computer, which has a browser for accessing an address, a card reader connected to the computer and also a data card insertable in the card reader in order to launch a specific address.

Many computer applications, such as home banking applications and game portals, are accessible under a specific Internet address. For that purpose, the user must enter the Internet address into his browser and if need be other details for user authentication. The Internet addresses are often relatively long and the user authentication requires further entries. Although for the most part Internet addresses and possibly also passwords can be stored, using the Internet is nevertheless a considerable problem for people with little experience of computers.

Efforts are therefore being made to facilitate access to certain applications and web pages.

DE 198 45 582 A1 describes a simplified use of a smart card, in which information is stored on the smart card and is used when executing a computer program outside the smart card. For that purpose, a card reader is connected to a computer and an associated background program is installed on the computer. By means of the background program, the computer recognises the insertion of a card into the card reader and reads out the information stored there. With the aid of this information, an interrelated program is started on the computer or at another location.

Although the start of a specific application can be considerably facilitated with this system, the system does assume that a specific background program is installed and is launched before insertion of the card.

The technical problem on which the invention is based is to specify a system in which the access to a specific address, in particular an IP address, is further simplified.

That problem is solved in accordance with the invention by the features of claim 1. The multimedia system according to the invention substantially comprises a computer, which has a browser for accessing an address, in particular an IP address, a card reader connected to the computer, as well as at least one data card having a card code and insertable in and readable by the card reader, wherein the card reader generates a data signal dependent on the card code for the computer, the data signal being so designed that it corresponds to keyboard signals for direct control of the browser using a specific address.

In this way, a background program running on the computer can be dispensed with. One merely uses the browser existing as standard on the computer, which is otherwise activated via the keyboard. Because the card reader now produces a data signal that corresponds to the equivalent keyboard signals, the browser can automatically retrieve the address, in particular an IP address, apparent from the data signal. It is therefore merely necessary for the card reader to be connected to the computer and for the data card to be inserted.

Further embodiments of the invention form the subject matter of the subsidiary claims.

According to a special embodiment of the invention, just a part of the specific address, in particular a part of an IP address, is present on the data card, whilst the other part of the address is stored in the card reader. This is of particular importance when the space available on the data card for the card code is insufficient for the entire address. Furthermore, a coding for controlling the content of the specific address is advantageously provided on the data card. This can be, for example, data for user authentication.

The specific address is preferably what is known as a URL.

The data card, and in particular the card code, can be of arbitrary design. Manufacture is especially simple and inexpensive when the card code is formed by printed storage electronics, in particular by printed conductive polymers.

Further advantages and embodiments of the invention are explained in detail hereafter by means of the description and the drawing.

The drawing illustrates a block diagram of the multimedia system.

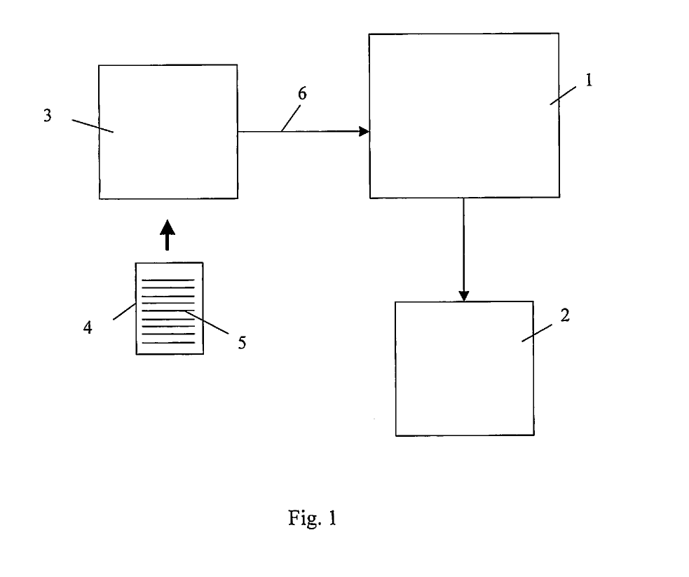

The multimedia system illustrated in FIG. 1 essentially comprises a computer 1, which has a browser for accessing an address 2, in particular an address in a local or remote network/computer network, a card reader 3 connected to the computer, as well as at least one data card 4 insertable in and readable by the card reader. The data card 4 has a card code 5, the card reader 3 producing a data signal 6 dependent on the card code for the computer 1. This data signal 6 is designed to correspond to keyboard signals for direct control of the browser using a specific address. In other words, insertion of the card 4 corresponds to a keyboard input with which a specific address can be retrieved.

The connection of computer 1 and card reader 3 is advantageously effected via a USB connection. In consequence, the user merely has to plug the USB plug of the card reader into a spare USB slot of the computer. Modern computers then automatically recognise the newly connected hardware. Because the card reader supplies a data signal that corresponds to conventional keyboard signals, an additional background program to be installed on the computer and which, if need be, has to convert the data signal, is therefore unnecessary.

The storage of complete and long web addresses and an optionally additionally required coding for controlling the content of a specific address often requires a lot of memory space, which can exceed the limited memory capacity of a data card. This may be the case, for example, when the card code 5 is formed by printed storage electronics of conductive polymers. For this particular case, it is proposed that only a part of the specific address is stored on the data card 4, whilst the other part of the specific address is stored in the card reader 3. Furthermore, the coding required for optional control of the content of the specific address is stored on the data card.

It is therefore possible for banks to provide the user with a card reader and with a personal data card to gain easy access to his customer account. By inserting the data card into the reader connected to his computer, the customer can immediately and automatically create access to the home page of his bank. In addition, the data necessary for user identification can also be stored on the card, so that the customer simply needs, if applicable, also to enter a PIN code to access his bank account.

According to one embodiment of the invention, the memory requirement of the data card is reduced as a result of the complete address comprising a variable portion, which is located on the data card 4, and a fixed portion, which is permanently programmed into the card reader 3. Each time the data card 4 is inserted in the card reader 3, the variable portion of the address and the permanent portion of the address are combined to form a complete final address, and the address opens up in the standard browser. So the data card can contain, for example, 96 bits, with 32 bits forming a part of the address and the remaining 64 bits being used for individual coding of the data card and for controlling a possible application.

If there is sufficient storage space on the data card 4, however, it is also conceivable for the entire address as well as a possible coding for controlling the content of the specific address to be stored in the card code. In this way, the card reader would be more versatile, as not just applications that are linked to the address component permanently stored in the card reader could be started.

By inserting the data card, it is therefore possible, for example, for the computer to retrieve web contents directly, the standard browser automatically initiating the correct display program (multimedia program) for showing or playing back the contents (image, music video, . . . ).

The above-described multimedia system is distinguished by an especially simple facility that even an untrained computer user can use to reach a specific address (IP address, address in a local or remote network).

1. A multimedia system having
a. a computer (1), which has a browser for accessing an address (2), in particular an IP address,
b. a card reader (3) connected to the computer and also
c. at least one data card (4) having a card code (5) and insertable in and readable by the card reader, wherein the card reader produces a data signal (6) dependent on the card code for the computer,
characterised in that the data signal of the card reader is designed to correspond to keyboard signals for direct control of the browser using a specific address.

2. A multimedia system according to claim 1, characterised in that a part of the specific address is stored on the data card (4) and a part of the specific address is stored in the card reader.

3. A multimedia system according to claim 1, characterised in that at least a part of the specific address and a coding for controlling the content of the specific address is contained on the data card (4).

4. A multimedia system according to claim 1, characterised in that the specific address is a URL.

5. A multimedia system according to claim 1, characterised in that a USB connection is provided for connection of the computer (1) and the card reader (3).

6. A multimedia system according to claim 1, characterised in that the computer (1) has multimedia programs for displaying or playing back contents of an address, the browser being designed so that it automatically starts the multimedia program(s) required at a specific address.

7. A multimedia system according to claim 1, characterised in that the data card (4) comprises printed storage electronics.

8. A multimedia system according to claim 1, characterised in that the storage electronics are formed by printed conductive polymers.
